(19) United States
(12) Patent Application Publication
(10) Pub. No.: US 2025/0091324 A1
(43) Pub. Date: Mar. 20, 2025

(54) MULTILAYER WOOD AND METAL SHEET MATERIALS AND METHODS OF MAKING SAME

(71) Applicant: Wood Steel Stone, Inc., Brooklyn, NY (US)

(72) Inventor: Chalres Grantham Wulster, Brooklyn, NY (US)

(21) Appl. No.: 18/886,309

(22) Filed: Sep. 16, 2024

Related U.S. Application Data
(63) Continuation-in-part of application No. 29/912,144, filed on Sep. 14, 2023.
(60) Provisional application No. 63/582,558, filed on Sep. 14, 2023.

(51) Int. Cl. B32B 15/10; B32B 7/12; B32B 37/12

(52) U.S. Cl. CPC B32B 15/10; B32B 7/12; B32B 37/12; B32B 2037/1253; B32B 2250/03; B32B 2250/04; B32B 2250/05; B32B 2250/40; B32B 2250/42; B32B 2307/7376; B32B 2309/12; B32B 2419/00

(57) ABSTRACT

The present disclosure provides multilayer sheet materials and methods of making the same. Specifically, layers of wood and metals are employed to construct multilayered sheets.

### PRIORITY CLAIM

This application claims priority to U.S. Provisional Patent Application Ser. No. 63/582,558, filed on Sep. 14, 2023, and is a continuation-in-part application of U.S. Design patent application Ser. No. 29/912,144, filed on Sep. 14, 2023, the entire contents of each of which are incorporated herein by reference and relied upon.

### BACKGROUND

Some improvements have been made with the use of particle board such as OSB (Oriented Strand Board). In today's environment stronger and stiffer building materials are in demand. Increasing strength and stiffness allows for a reduced overall thickness as compared with plywood or particle board. Additionally, plywood, particle board and OSB also do not shield electromagnetic waves, provide chemical or abrasion resistance. Instead, additional coatings are typically applied to plywood, particle board and OSB to provide these properties. Secondary operations require additional expense.

### SUMMARY

The present disclosure provides multilayer sheet materials and methods of making same.

In some embodiments, the present disclosure provides a multilayer sheet material comprising: a first wood layer; a second metal layer adjacent to the first wood layer; and a third layer adjacent to either the first wood layer or the second metal layer.

In other embodiments, the present disclosure provides a multilayer sheet material comprising: a first wood layer; a second metal layer adjacent to the first wood layer; a third wood layer adjacent to the second metal layer; and a fourth metal layer adjacent to the third wood layer.

In other embodiments, the present disclosure provides a method of making a multilayer sheet material, the method comprising: placing a first layer onto a bottom surface of a press having a top and bottom surface; applying an adhesive to the first layer, placing a second layer onto the first layer; applying an adhesive to the second layer; placing a third layer onto the second layer; lowering the top surface of the press onto the third layer; applying an adhesion pressure to first layer, second layer and third layer; and maintaining the adhesion pressure for an adhesion duration.

In some embodiments, the present disclosure provides a method of making a multilayer sheet material, the method comprising: placing a first surface of first layer having a first surface and a second surface onto a bottom surface of a press having a top and bottom surface; applying an adhesive to the second surface of the first layer; applying an adhesive to a first surface of a second layer having a first and second surface; placing the first surface of the second layer onto the second surface of the first layer; applying an adhesive to the second surface of the second layer; applying an adhesive to the first surface of a third layer having a first surface and a second surface; placing the first surface of the third layer onto the second surface of the second layer; lowering the top surface of the press onto the second surface of the third layer; applying an adhesion pressure to first layer, second layer and third layer; and maintaining the adhesion pressure for an adhesion duration.

Multilayer sheet materials consistent with the present disclosure are capable of being machined (e.g., cut, shaped, drilled, etc.) using standard cutting tools.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an isometric view of a multilayer sheet material consistent with the present disclosure and having three layers.

FIG. 2 shows an isometric view of a multilayer sheet material consistent with the present disclosure and having four layers.

FIG. 3 shows an isometric view of a multilayer sheet material consistent with the present disclosure and having five layers.

FIG. 4 shows an isometric view of a curved multilayer sheet material consistent with the present disclosure and having three layers.

FIG. 5 shows an isometric view of a press pressing a multilayer sheet material during a curing step consistent with the present disclosure.

FIG. 6 shows a flowchart of one method of making a multilayer sheet material consistent with the present disclosure.

FIG. 7 shows a partial flowchart of another method of making a multilayer sheet material consistent with the present disclosure.

FIG. 8 shows the remaining partial flow chart of the method of making a multilayer sheet material depicted in FIG. 7.

FIG. 9 is a photograph of a bracelet comprising a multilayer sheet material consistent with the present disclosure.

FIG. 10 is an enlarged portion of the photograph of FIG. 9.

FIG. 11 is a photograph of a portion of the interior and edge surfaces of the bracelet of FIG. 9.

FIG. 12 is a photograph of a bracelet comprising a multilayer sheet material consistent with the present disclosure.

FIG. 13 is a photograph of a console table comprising a multilayer sheet material consistent with the present disclosure.

FIG. 14 is an enlarged portion of the photograph of FIG. 13.

FIG. 15 is a photograph of a multilayer sheet material consistent with the present disclosure.

FIG. 16 is a photograph of a portion of the bottom side of the multilayer sheet material of FIG. 15.

FIG. 17 is a photograph of a corner portion of the multilayer sheet material of FIG. 15.

FIG. 18 is a photograph of a wall sconce comprising two multilayer sheet materials consistent with the present disclosure.

FIG. 19 is an enlarged portion of the photograph of FIG. 18.

FIG. 20 is a photograph of a wall sconce comprising two multilayer sheet materials consistent with the present disclosure.

### DETAILED DESCRIPTION

In general, the disclosure relates to building materials used in construction; specifically, an improved plywood having a total thickness of about 0.5 millimeters to about 32 millimeters.

Multilayer sheet materials consistent with this disclosure generally include two or more layers; at least one layer consists essentially or consists of wood, while at least one other layer consists essentially of or consists of metal. In some embodiments, the multilayer sheet material may include an adhesive layer disposed between the wood layer and the metal layer. In some embodiments, the first wood layer has a thickness of about 0.2 mm to about 8 mm. The first wood layer comprises, consists essentially of, or consists of a wood capable of being adhered to the metal layer with an adhesive. The first wood layer may be selected from a group consisting of walnut, oak, cherry, cedar, mahogany, ash, maple, redwood, hickory, ebony, and sapele. The second metal layer has a thickness of about 0.2 mm to 12 mm.

The second metal layer may comprise, consist essentially of, or consists of a machinable metal. In some examples, the second metal layer may be selected from a list consisting of brass, bronze, copper, aluminum, zinc, silver, a precious metal, and free machining steel. In some embodiments, the second metal layer is a solid sheet of metal. In other embodiments, the second metal layer is a perforated, expanded, mesh, or grated metal material.

The third layer of the multilayer sheet material may have thickness of about 0.2 mm to about 8 mm. In some examples, the third layer comprises, consists essentially of, or consists of a second wood capable of being adhered to metal with an adhesive. Additionally, in some examples, the third layer comprises, consists essentially of, or consists of a second machinable metal. The second machinable metal may be selected from a group consisting of brass, bronze, copper, aluminum, zinc, silver, a precious metal, and free machining steel.

An adhesive may be used to adhere the first wood layer to the second layer or the second and third layers to each other. In some examples, the adhesive may have a modulus of elasticity of about 150,000 psi and may additionally have a cured hardness of about 75 Shore D and a tensile strength of 25,800 psi (ASTM D638, ASTM is an abbreviation for American Society for Testing and Materials). Additionally, the cured adhesive may have a flexural strength of not less than 4,000 psi (ASTM D-790). In yet other examples, the adhesive may have a tensile adhesion rating of not less than about 1,300 psi as measured by a PATTI (Pneumatic Adhesion Tensile Testing Instrument) device using vertical grain teak prepared with 80-grit sandpaper parallel to the grain of the teak.

Multilayer sheet material disclosed herein has many benefits. Standard woodworking tools can be used to work the multilayer sheet material into various parts. For example, the disclosed multilayer sheet material may be worked with miter saws, table saws, cnc machining tools, routers, drills, and sanders. The disclosed multilayer sheet material is more rigid than a plywood sheet of same thickness. Rigidity may be a significant factor in some cases.

Additionally, wood and perhaps metal materials may be selected for appearance preferences. For instance mahogany could be used as a very thin layer for aesthetics. This provides lower costs since internal layers may be of less costly material.

Another advantage of the disclosed multilayer sheet material is provided by the metal material. Metal is a very effective shielding material for electromagnetic radiation. The disclosed multilayer sheet material has a built-in shielding property that is particularly helpful in today's cell phone and wireless environment.

Multilayer sheet materials 10 consistent with the present disclosure may, in some embodiments, include wood layers and metal layers each having the same thickness. In such embodiments, the metal layers appear to have a relatively greater thickness than the wood layers.

In other embodiments, each wood layer of a multilayer sheet material 10 has a thickness greater than the thickness of each metal layer. For example and without limitation, the thickness of each wood layer may be about 15% to about 30% greater than the thickness of each metal layer, such as about 15% greater, about 16% greater, about 17% greater, about 18% greater, about 19% greater, about 20% greater, about 21% greater, about 22% greater, about 23% greater, about 24% greater, about 25% greater, about 26% greater, about 27% greater, about 28% greater, about 29% greater, or about 30% greater than the thickness of each metal layer. In such embodiments, the wood layers and the metal layers of the multilayer sheet 10 appear to have a similar or equal thickness.

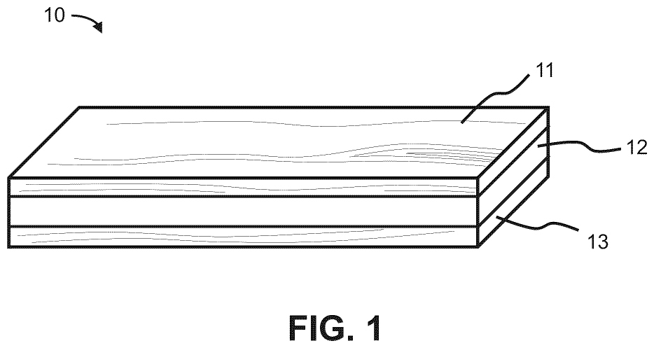

FIG. 1 depicts a multilayered sheet material 10. The multilayer sheet material 10 in this embodiment includes three layers of material. First wood layer 11 is adjacent to metal layer 12 and a second wood layer 13 is adjacent to the metal layer 12 and opposite the first wood layer 11. In some embodiments, an adhesive layer (not shown) may be disposed between first wood layer 11 and the metal layer 12. Additionally, an adhesive layer (not shown) may be disposed between the metal layer 12 and the second wood layer 13.

The first wood layer 11 may have a thickness of about 0.2 millimeter (mm) to about 8 mm. In some embodiments, the first wood layer 11 may comprise or consist of a wood material that is able to be adhered to metal layer 12 by an adhesive. The first wood layer 11 may comprise or consist of a wood material selected for aesthetic purposes. Wood material such as walnut, oak, cherry, cedar, mahogany, ash, maple, redwood, hickory, ebony, and sapele may be used together or singularly as the first wood layer 11.

The metal layer 12 may have a thickness of about 0.2 mm to about 12 mm. In some embodiments, the metal layer 12 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for metal layer 12 may be selected at least in part for aesthetic reasons, its mechanical properties, and/or its electromagnetic properties.

The metal layer 12 may provide strength and stiffness properties. For instance a material such as free machining steel would have a modulus of elasticity of about 30,000,000 psi. A modulus of elasticity of this magnitude generally provides for a much stiffer multilayer sheet material 10 compared to a comparative multilayer sheet material including a softer metal such as aluminum (having a modulus of elasticity of 10,000,000 psi). Additionally, a material such as steel (having a yield strength of about 36,000 psi to 150,000 psi) used as metal layer 12 will provide a multilayer sheet material 10 having much more strength than a comparable multilayer sheet material including a metal having a lower yield strength (e.g., aluminum having a yield strength of about 35,000 psi to 44,000 psi) as metal layer 12.

Metal layer 12 material may, in some embodiments, provide magnetic properties as well. For example, a ferrous material such as machinable steel may be used as metal layer 12. Such multilayer sheet materials 10 may possess advantageous magnetic properties and aesthetically pleasing properties. For instance, a magnet may be used to maneuver a multilayer sheet material 10 having a magnetic metal layer 12 material in such embodiments.

Metal layer 12 may in some embodiments impart electromagnetic shielding properties on the multilayer sheet material 10. Such multilayer sheet materials 10 may possess advantageous electromagnetic shielding properties and aesthetically pleasing properties. For example, a multilayer sheet material 10 including an electromagnetic shielding metal layer 12 material may be used to construct aesthetically pleasing structures that impede or prevent transmission of electromagnetic waves in such embodiments.

In some embodiments, the metal layer 12 is a solid sheet of metal. In other embodiments, the metal layer 12 is a perforated, expanded, mesh, or grated metal material.

Second wood layer 13 is disposed adjacent to metal layer 12 opposite the first wood layer 11. The second wood layer 13 may comprise or consist of the same wood as first wood layer 11 or a different wood as first wood layer 11. The grain pattern of the second wood layer 13 may be oriented generally parallel to the grain pattern of the first wood layer 11 in some embodiments. In other embodiments, the grain pattern of the second wood layer 13 is oriented skewed (e.g., antiparallel or orthogonal) to the grain pattern of the first wood layer 11.

The second wood layer 13 may have a thickness of about 0.3 mm to about 8 mm. In some embodiments, the second wood layer 13 may comprise or consist of a wood material that is able to be adhered to metal layer 12 by an adhesive. The second wood layer 13 may comprise or consist of a wood material selected for aesthetic purposes. Wood material such as walnut, oak, cherry, cedar, mahogany, ash, maple, redwood, hickory, ebony, and sapele may be used together or singularly as the second wood layer 13.

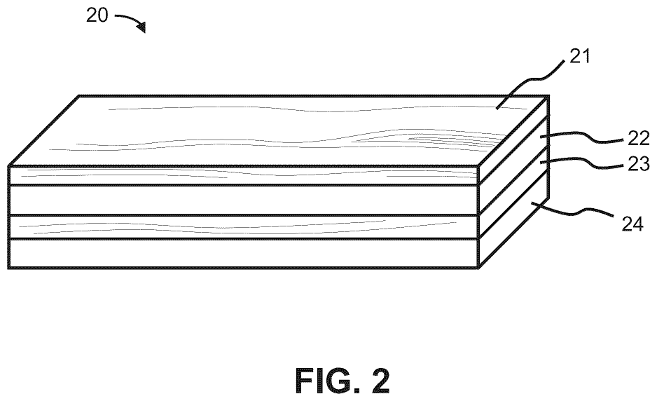

FIG. 2 depicts a multilayer sheet material 20 including a top layer that is wood while the bottom layer is metal. In such embodiments the multilayer sheet material 20 includes an even number of alternating layers of wood and metal. For example, multilayer sheet material 20 may include four layers: a first layer 21, a second layer 22 adjacent to the first layer, a third layer 23 adjacent to the second layer and opposite the first layer 21, and a fourth layer 24 adjacent to the third layer 23 and opposite the second layer 22. The first layer 21 may be wood and may have a thickness of about 0.3 millimeter (mm) to about 8 mm. In some embodiments, the first layer 21 comprises or consists of a wood material that is able to be adhered to the second (metal) layer 22 by an adhesive. The first layer 21 may comprise or consist of a wood material selected for aesthetic purposes. Wood material such as walnut, oak, cherry, cedar, mahogany, ash, maple, redwood, hickory, ebony, and sapele may be used together or singularly as the first layer 21.

The second layer 22 consists of a metal material and has a thickness of about 0.03 mm to about 12 mm. In some embodiments, the second layer 22 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for second layer 22 may be selected at least in part for aesthetic reasons, its mechanical properties, and/or its electromagnetic properties. In some embodiments, the second layer 22 is a solid sheet of metal. In other embodiments, the second layer 22 is a perforated, expanded, mesh, or grated metal material.

The second layer 22 may provide strength and stiffness properties. For instance a material such as free machining steel would have a modulus of elasticity of about 30,000,000 psi. A modulus of elasticity of this magnitude generally provides for a much stiffer multilayer sheet material 20 compared to a comparative multilayer sheet material including a softer metal such as aluminum (having a modulus of elasticity of 10,000,000 psi).

Additionally, a material such as steel (having a yield strength of about 36,000 psi to 150,000 psi) used as second layer 22 will provide a multilayer sheet material 20 having much more strength than a comparable multilayer sheet material including a metal having a lower yield strength (e.g., aluminum having a yield strength of about 35,000 psi to 44,000 psi) as second layer 22.

Second layer 22 material may, in some embodiments, provide magnetic properties as well. For example, a ferrous material such as machinable steel may be used as second layer 22. Such multilayer sheet materials 20 may possess advantageous magnetic properties and aesthetically pleasing properties. For instance, a magnet may be used to maneuver a multilayer sheet material 20 having a magnetic second layer 22 material in such embodiments.

Second layer 22 may in some embodiments impart electromagnetic shielding properties on the multilayer sheet material 20. Such multilayer sheet materials 20 may possess advantageous electromagnetic shielding properties and aesthetically pleasing properties. For example, a multilayer sheet material 20 including an electromagnetic shielding second layer 22 material may be used to construct aesthetically pleasing structures that impede or prevent transmission of electromagnetic waves in such embodiments.

Third layer 23 consists of a wood material and is disposed adjacent to second layer 22 opposite the first layer 21. The third layer 23 may comprise or consist of the same wood as first layer 21 or a different wood as first layer 21. The grain pattern of the third layer 23 may be oriented generally parallel to the grain pattern of the first layer 21 in some embodiments. In other embodiments, the grain pattern of the third layer 23 is oriented skewed (e.g., antiparallel or orthogonal) to the grain pattern of the first layer 21.

The third layer 23 may have a thickness of about 0.3 mm to about 8 mm. In some embodiments, the third layer 23 may comprise or consist of a wood material that is able to be adhered to second layer 22 by an adhesive. The third layer 23 may comprise or consist of a wood material selected for aesthetic purposes. Wood material such as walnut, oak, cherry, cedar, mahogany, ash, maple, redwood, hickory, ebony, and sapele may be used together or singularly as the third layer 23.

The fourth layer 24 consists of a metal material and has a thickness of about 0.03 mm to about 12 mm. The metal of fourth layer 24 may be the same as the metal of second layer 22 in some embodiments; in other embodiments, the fourth layer 24 consists of a metal material that is different than the metal of the second layer 22. In some embodiments, the fourth layer 24 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for fourth layer 24 may be selected at least in part for aesthetic reasons, its mechanical properties, and/or its electromagnetic properties. In some embodiments, the fourth layer 24 is a solid sheet of metal. In other embodiments, the fourth layer 24 is a perforated, expanded, mesh, or grated metal material.

The fourth layer 24 may provide strength and stiffness properties. For instance a material such as free machining steel would have a modulus of elasticity of about 30,000,000 psi. A modulus of elasticity of this magnitude generally provides for a much stiffer multilayer sheet material 20 compared to a comparative multilayer sheet material including a softer metal such as aluminum (having a modulus of elasticity of 10,000,000 psi).

Additionally, a material such as steel (having a yield strength of about 36,000 psi to 150,000 psi) used as fourth layer 24 will provide a multilayer sheet material 20 having much more strength than a comparable multilayer sheet material including a metal having a lower yield strength (e.g., aluminum having a yield strength of about 35,000 psi to 44,000 psi) as fourth layer 24.

The fourth layer 24 material may, in some embodiments, provide magnetic properties as well. For example, a ferrous material such as machinable steel may be used as fourth layer 24. Such multilayer sheet materials 20 may possess advantageous magnetic properties and aesthetically pleasing properties. For instance, a magnet may be used to maneuver a multilayer sheet material 20 having a magnetic fourth layer 24 material in such embodiments.

The fourth layer 24 may in some embodiments impart electromagnetic shielding properties on the multilayer sheet material 20. Such multilayer sheet materials 20 may possess advantageous electromagnetic shielding properties and aesthetically pleasing properties. For example, a multilayer sheet material 20 including an electromagnetic shielding fourth layer 24 material may be used to construct aesthetically pleasing structures that impede or prevent transmission of electromagnetic waves in such embodiments.

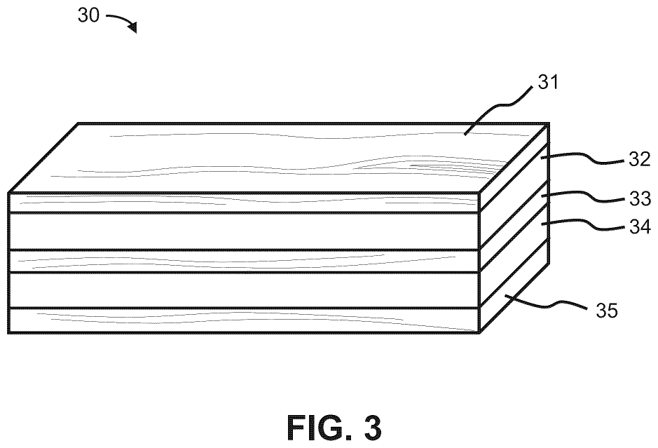

FIG. 3 depicts a multilayer sheet material 30 including a top layer that is wood and a bottom layer that is also wood. In such embodiments, the multilayer sheet material 30 includes an odd number of alternating layers of wood and metal. For example, multilayer sheet material 30 may include five layers: a first layer 31, a second layer 32 adjacent to the first layer, a third layer 33 adjacent to the second layer and opposite the first layer 31, a fourth layer 34 adjacent to the third layer 33 and opposite the second layer 32, and a fifth layer 35 adjacent to the fourth layer 34 and opposite the third layer 33. The first layer 31 may be wood and may have a thickness of about 0.3 millimeter (mm) to about 8 mm. In some embodiments, the first layer 31 comprises or consists of a wood material that is able to be adhered to the second (metal) layer 32 by an adhesive. The first layer 31 may comprise or consist of a wood material selected for aesthetic purposes. Wood material such as walnut, oak, cherry, cedar, mahogany, ash, maple, redwood, hickory, ebony, and sapele may be used together or singularly as the first layer 31.

The second layer 32 consists of a metal material and has a thickness of about 0.03 mm to about 12 mm. In some embodiments, the second layer 32 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for second layer 32 may be selected at least in part for aesthetic reasons, its mechanical properties, and/or its electromagnetic properties. In some embodiments, the second layer 32 is a solid sheet of metal. In other embodiments, the second layer 32 is a perforated, expanded, mesh, or grated metal material.

The second layer 32 may provide strength and stiffness properties. For instance a material such as free machining steel would have a modulus of elasticity of about 30,000,000 psi. A modulus of elasticity of this magnitude generally provides for a much stiffer multilayer sheet material 30 compared to a comparative multilayer sheet material including a softer metal such as aluminum (having a modulus of elasticity of 10,000,000 psi).

Additionally, a material such as steel (having a yield strength of about 36,000 psi to 150,000 psi) used as second layer 32 will provide a multilayer sheet material 30 having much more strength than a comparable multilayer sheet material including a metal having a lower yield strength (e.g., aluminum having a yield strength of about 35,000 psi to 44,000 psi) as second layer 32.

Second layer 32 material may, in some embodiments, provide magnetic properties as well. For example, a ferrous material such as machinable steel may be used as second layer 32. Such multilayer sheet materials 30 may possess advantageous magnetic properties and aesthetically pleasing properties. For instance, a magnet may be used to maneuver a multilayer sheet material 30 having a magnetic second layer 32 material in such embodiments.

Second layer 32 may in some embodiments impart electromagnetic shielding properties on the multilayer sheet material 30. Such multilayer sheet materials 30 may possess advantageous electromagnetic shielding properties and aesthetically pleasing properties. For example, a multilayer sheet material 30 including an electromagnetic shielding second layer 32 material may be used to construct aesthetically pleasing structures that impede or prevent transmission of electromagnetic waves in such embodiments.

Third layer 33 consists of a wood material and is disposed adjacent to second layer 32 opposite the first layer 31. The third layer 33 may comprise or consist of the same wood as first layer 31 or a different wood as first layer 31. The grain pattern of the third layer 33 may be oriented generally parallel to the grain pattern of the first layer 31 in some embodiments. In other embodiments, the grain pattern of the third layer 33 is oriented skewed (e.g., antiparallel or orthogonal) to the grain pattern of the first layer 31.

The third layer 33 may have a thickness of about 0.3 mm to about 8 mm. In some embodiments, the third layer 33 may comprise or consist of a wood material that is able to be adhered to second layer 32 by an adhesive. The third layer 33 may comprise or consist of a wood material selected for aesthetic purposes. Wood material such as walnut, oak, cherry, cedar, mahogany, ash, maple, redwood, hickory, ebony, and sapele may be used together or singularly as the third layer 33.

The fourth layer 34 consists of a metal material and has a thickness of about 0.03 mm to about 12 mm. The metal of fourth layer 34 may be the same as the metal of second layer 32 in some embodiments; in other embodiments, the fourth layer 34 consists of a metal material that is different than the metal of the second layer 32. In some embodiments, the fourth layer 34 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for fourth layer 34 may be selected at least in part for aesthetic reasons, its mechanical properties, and/or its electromagnetic properties. In some embodiments, the fourth layer 34 is a solid sheet of metal. In other embodiments, the fourth layer 34 is a perforated, expanded, mesh, or grated metal material.

The fourth layer 34 may provide strength and stiffness properties. For instance a material such as free machining steel would have a modulus of elasticity of about 30,000,000 psi. A modulus of elasticity of this magnitude generally provides for a much stiffer multilayer sheet material 30 compared to a comparative multilayer sheet material including a softer metal such as aluminum (having a modulus of elasticity of 10,000,000 psi).

Additionally, a material such as steel (having a yield strength of about 36,000 psi to 150,000 psi) used as fourth layer 34 will provide a multilayer sheet material 30 having much more strength than a comparable multilayer sheet material including a metal having a lower yield strength (e.g., aluminum having a yield strength of about 35,000 psi to 44,000 psi) as fourth layer 34.

The fourth layer 34 material may, in some embodiments, provide magnetic properties as well. For example, a ferrous material such as machinable steel may be used as fourth layer 34. Such multilayer sheet materials 30 may possess advantageous magnetic properties and aesthetically pleasing properties. For instance, a magnet may be used to maneuver a multilayer sheet material 30 having a magnetic fourth layer 34 material in such embodiments.

The fourth layer 34 may in some embodiments impart electromagnetic shielding properties on the multilayer sheet material 30. Such multilayer sheet materials 30 may possess advantageous electromagnetic shielding properties and aesthetically pleasing properties. For example, a multilayer sheet material 30 including an electromagnetic shielding fourth layer 34 material may be used to construct aesthetically pleasing structures that impede or prevent transmission of electromagnetic waves in such embodiments.

Fifth layer 35 consists of a wood material and is disposed adjacent to the fourth layer 34 opposite the third layer 33. The fifth layer 35 may comprise or consist of the same wood as first layer 31 or a different wood as first layer 31. The grain pattern of the fifth layer 35 may be oriented generally parallel to the grain pattern of the first layer 31 in some embodiments. In other embodiments, the grain pattern of the fifth layer 35 is oriented skewed (e.g., antiparallel or orthogonal) to the grain pattern of the first layer 31.

The fifth layer 35 may have a thickness of about 0.3 mm to about 8 mm. In some embodiments, the fifth layer 35 may comprise or consist of a wood material that is able to be adhered to fourth layer 34 by an adhesive. The fifth layer 35 may comprise or consist of a wood material selected for aesthetic purposes. Wood material such as walnut, oak, cherry, cedar, mahogany, ash, maple, redwood, hickory, ebony, and sapele may be used together or singularly as the fifth layer 35.

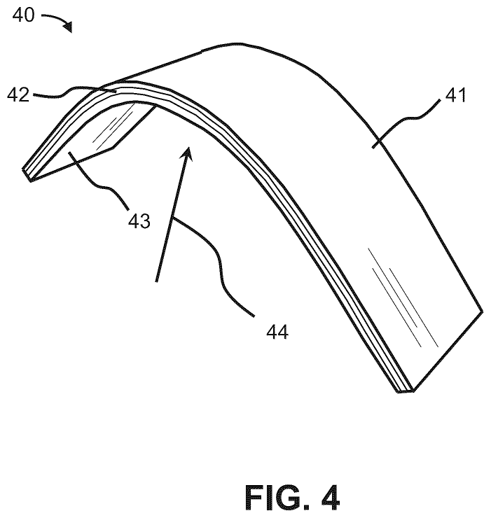

FIG. 4 depicts a three-multilayer sheet material 40 having a first layer 41, a second layer 42 adjacent to the first layer 41, and a third layer 43 adjacent to the second layer 42 and opposite the first layer 41. In some embodiments, multilayer sheet material 40 may be curved along a radius 44 or any other suitable contour. In some embodiments, the curved shape is imparted on the multilayer sheet 40 during the adhesion process. This process generally allows for constructing various shapes.

In the example curved multilayer sheet 40 shown in FIG. 4, for example, the first layer 41 may be wood and may have a thickness of about 0.3 millimeter (mm) to about 8 mm. In some embodiments, the first layer 41 comprises or consists of a wood material that is able to be adhered to the second (metal) layer 42 by an adhesive. The first layer 41 may comprise or consist of a wood material selected for aesthetic purposes. Wood material such as walnut, oak, cherry, cedar, mahogany, ash, maple, redwood, hickory, ebony, and sapele may be used together or singularly as the first layer 41.

The second layer 42 consists of a metal material and has a thickness of about 0.03 mm to about 12 mm. In some embodiments, the second layer 42 may comprise or consist of a metal that is machinable by conventional machining processes, for example having a machinability of 140% as specified by the AISI (American Iron and Steel Institute). Conventional machining processes may include but are not limited to: miter saws, tables saws, computer numerically controlled (cnc) machines, routers, drills and sanders. Metal material such as brass, bronze, copper, aluminum, zinc, silver, a precious metal, and free machining steel may be selected based on the metal properties. Example machinable metals may include but are not limited to: brass, bronze, copper, aluminum, zinc, silver, a precious metal, or free machining steel, as well any combination of brass, bronze, copper, aluminum, zinc, silver, a precious metal, and free machining steel. In some embodiments, the material chosen for second layer 42 may be selected at least in part for aesthetic reasons, its mechanical properties, and/or its electromagnetic properties. In some embodiments, the second layer 42 is a solid sheet of metal. In other embodiments, the second layer 42 is a perforated, expanded, mesh, or grated metal material.

The second layer 42 may provide strength and stiffness properties. For instance a material such as free machining steel would have a modulus of elasticity of about 30,000,000 psi. A modulus of elasticity of this magnitude generally provides for a much stiffer multilayer sheet material 40 compared to a comparative multilayer sheet material including a softer metal such as aluminum (having a modulus of elasticity of 10,000,000 psi).

Additionally, a material such as steel (having a yield strength of about 36,000 psi to 150,000 psi) used as second layer 42 will provide a multilayer sheet material 40 having much more strength than a comparable multilayer sheet material including a metal having a lower yield strength (e.g., aluminum having a yield strength of about 35,000 psi to 44,000 psi) as second layer 42.

Second layer 42 material may, in some embodiments, provide magnetic properties as well. For example, a ferrous material such as machinable steel may be used as second layer 42. Such multilayer sheet materials 40 may possess advantageous magnetic properties and aesthetically pleasing properties. For instance, a magnet may be used to maneuver a multilayer sheet material 40 having a magnetic second layer 42 material in such embodiments.

Second layer 42 may in some embodiments impart electromagnetic shielding properties on the multilayer sheet material 40. Such multilayer sheet materials 40 may possess advantageous electromagnetic shielding properties and aesthetically pleasing properties. For example, a multilayer sheet material 40 including an electromagnetic shielding second layer 42 material may be used to construct aesthetically pleasing structures that impede or prevent transmission of electromagnetic waves in such embodiments.

Third layer 43 consists of a wood material and is disposed adjacent to second layer 42 opposite the first layer 41. The third layer 43 may comprise or consist of the same wood as first layer 41 or a different wood as first layer 41. The grain pattern of the third layer 43 may be oriented generally parallel to the grain pattern of the first layer 41 in some embodiments. In other embodiments, the grain pattern of the third layer 43 is oriented skewed (e.g., antiparallel or orthogonal) to the grain pattern of the first layer 41.

The third layer 43 may have a thickness of about 0.3 mm to about 8 mm. In some embodiments, the third layer 43 may comprise or consist of a wood material that is able to be adhered to second layer 42 by an adhesive. The third layer 43 may comprise or consist of a wood material selected for aesthetic purposes. Wood material such as walnut, oak, cherry, cedar, mahogany, ash, maple, redwood, hickory, ebony, and sapele may be used together or singularly as the third layer 43.

In some embodiments, the curved shape 44 is imparted on multilayer sheet 40 by disposing adhesive between the first layer 41 and the second layer 42, and between the second layer 42 and the third layer 43; and placing the stack of layers 41-43 and adhesive into a press that includes complementary contoured top and bottom forms. Application of pressure to the multilayer sheet 40 as the adhesive cures between the layers 41-43 forms the curve shape 44 in the multilayer sheet 40.

In other embodiments, the curved shape 44 is imparted on multilayer sheet 40 by disposing adhesive between the first layer 41 and the second layer 42, and between the second layer 42 and the third layer 43; and placing the stack of layers 41-43 and adhesive into a vacuum press.

The adhesive disposed between the individual layers of a multilayer sheet 10,20,30,40 may be any suitable adhesive for bonding the wood layer to the metal layer. For example and without limitation, in some cases G/flex® 650 epoxy (West System®, Bay City, Michigan) may be used. However, many adhesive products are available. For instance, phenolic adhesives, liquid epoxies, epoxies and glues may be used. For instance, an adhesive may be used and may have a modulus of elasticity of about 150,000 PSI. An adhesive may be used which includes a hardness of 75 Shore D after curing. In other examples, an adhesive may have a tensile strength not less than about 2,500 PSI (as determined by test technique ASTM D638). The adhesive may have a flexural strength of not less than 4,000 PSI (as determined by test technique ASTM D-790). Additionally, the adhesive may have a tensile adhesion rating of not less than about 1,300 psi (as determined by a PATTI device using vertical grain teak prepared with 80-grit sandpaper parallel to the teak grain). In some embodiments, the epoxy is dyed to resemble the color of the adjacent wood layer.

In some embodiments, the present disclosure provides a multilayer sheet material comprising: a first wood layer; a second metal layer adjacent to the first wood layer; and a third layer adjacent to either the first wood layer or the second metal layer. In some embodiments, the multilayer sheet material further comprises an adhesive layer disposed between the first wood layer and the second metal layer. In some embodiments, the first wood layer has a thickness of about 0.2 mm to about 8 mm. In some embodiments, the first wood layer comprises, consists essentially of, or consists of a wood capable of being adhered to metal with an adhesive. In some embodiments, the first wood layer is selected from the group consisting of: walnut, oak, cherry, cedar, mahogany, ash, maple, redwood, hickory, ebony, and sapele. In some embodiments, the second metal layer has a thickness of about 0.2 mm to about 12 mm. In some embodiments, the second metal layer comprises, consists essentially of, or consists of a machinable metal. In some embodiments, the machinable metal is selected from the group consisting of: brass, bronze, copper, aluminum, zinc, silver, a precious metal, and free machining steel. In some embodiments, the third layer is adjacent to the second metal layer and has a thickness of about 0.2 mm to about 8 mm. In some embodiments, the third layer comprises, consists essentially of, or consists of a second wood capable of being adhered to metal with an adhesive. In some embodiments, the first wood layer is selected from the group consisting of: walnut, oak, cherry, cedar, mahogany, ash, maple, redwood, hickory, ebony, and sapele. In some embodiments, the third layer is adjacent to the first wood layer and has a thickness of about 0.2 mm to about 12 mm. In some embodiments, the third layer comprises, consists essentially of, or consists of a second machinable metal. In some embodiments, the second machinable metal is selected from the group consisting of: brass, bronze, copper, aluminum, zinc, silver, a precious metal, and free machining steel. In some embodiments, the multilayer sheet material further includes an adhesive layer disposed between the first wood layer and the second metal layer. In some embodiments, the adhesive layer comprises, consists essentially of, or consists of a liquid epoxy. In some embodiments, the adhesive has a modulus of elasticity of about 150,000 PSI. In some embodiments, the adhesive has, after curing, a hardness of about 75 Shore D. In some embodiments, the adhesive has, after curing, a tensile strength not less than about 2,500 psi (ASTM D638). In some embodiments, the adhesive has, after curing, a flexural strength of not less than 4,000 psi (ASTM D-790). In some embodiments, the adhesive has a tensile adhesion rating of not less than about 1,300 psi (e.g., as measured by a PATTI device using vertical grain teak prepared with 80-grit sandpaper parallel to grain of the teak). In some embodiments, the adhesive is G/flex® 650 epoxy (West System®, Bay City, Michigan). In some embodiments, the multilayer sheet material further comprises an adhesive layer disposed between the second metal layer and the third layer. In some embodiments, the adhesive layer comprises, consists essentially of, or consists of a liquid epoxy. In some embodiments, the liquid epoxy has a modulus of elasticity of about 150,000 PSI. In some embodiments, the liquid epoxy has, after curing, a hardness of about 75 Shore D. In some embodiments, the multilayer sheet material further comprises an adhesive layer disposed between the first wood layer and the third layer. In some embodiments, the adhesive layer comprises, consists essentially of, or consists of a liquid epoxy. In some embodiments, the liquid epoxy has a modulus of elasticity of about 150,000 PSI. In some embodiments, the liquid epoxy has, after curing, a hardness of about 75 Shore D. In some embodiments, the multilayer sheet material has a total thickness of about 0.5 mm to about 32 mm. In some embodiments, the multilayer sheet material has a machinability rating not less than about 140% (AISI).

In some embodiments, the present disclosure provides a multilayer sheet material comprising: a first wood layer; a second metal layer adjacent to the first wood layer; a third wood layer adjacent to the second metal layer; and a fourth metal layer adjacent to the third wood layer. In some embodiments, the first wood layer has a thickness of about 0.2 mm to about 8 mm. In some embodiments, the first wood layer comprises, consists essentially of, or consists of a wood capable of being adhered to metal with an adhesive. In some embodiments, the second metal layer has a thickness of about 0.2 mm to about 12 mm. In some embodiments, the second metal layer comprises, consists essentially of, or consists of a machinable metal. In some embodiments, the third wood layer has a thickness of about 0.2 mm to about 8 mm. In some embodiments, the third wood layer comprises, consists essentially of, or consists of a wood capable of being adhered to metal with an adhesive. In some embodiments, the fourth metal layer has a thickness of about 0.2 mm to about 12 mm. In some embodiments, the fourth metal layer comprises, consists essentially of, or consists of a machinable metal. In some embodiments, the multilayer sheet material further comprises a fifth metal layer disposed adjacent to first wood layer. In some embodiments, the fifth metal layer has a thickness of about 0.2 mm to about 12 mm. In some embodiments, the fifth metal layer comprises, consists essentially of, or consists of a machinable metal. In some embodiments, the multilayer sheet material further comprises a fifth wood layer disposed adjacent to fourth metal layer. In some embodiments, the fifth wood layer has a thickness of about 0.2 mm to about 8 mm. In some embodiments, the fifth wood layer comprises, consists essentially of, or consists of a wood capable of being adhered to metal with an adhesive. In some embodiments, the multilayer sheet material has a total thickness of about 1.2 mm to about 32 mm.

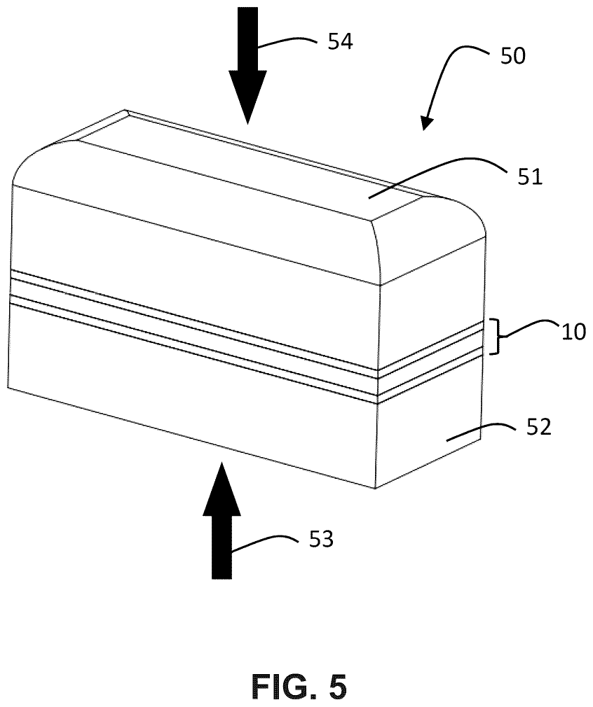

FIG. 5 depicts a press 50 that holds layers of a multilayer sheet material during an adhesion process. Press 50 may include press top 51 and press bottom 52. Multilayer sheet material 10 is shown in press 50. Use of multilayer sheet material 10 is used as illustrative and it should be understood that any number of layers may be constructed in press 50. During an adhesion process adhesive may be applied and pressure may be used.

Methods for manufacturing a multilayer sheet material consistent with the present disclosure are also disclosed herein. Generally, a method for making a multilayer sheet material consistent with the present disclosure comprises adhering alternating layers of wood and metal to each other with an adhesive, and then curing the adhesive (optionally under pressure) to form the multilayer sheet material. Adhesive may be applied with a roller to both sides of a layer material or to a single side if the layer is not attached to another layer (i.e., an outside layer). Many differing different adhesives may be used, including but not limited to epoxy, liquid epoxy, and phenolic adhesives. Pressure is used to adhere the layers to each other. In one embodiment, the layers are subjected to pressure at about 10-15 psig for 4-16 hours at ambient temperature, or for a shorter duration at an elevated temperature. In other embodiments, the layers are adhered to each other under vacuum (e.g., via a vacuum press) for a time sufficient to cure the adhesive.

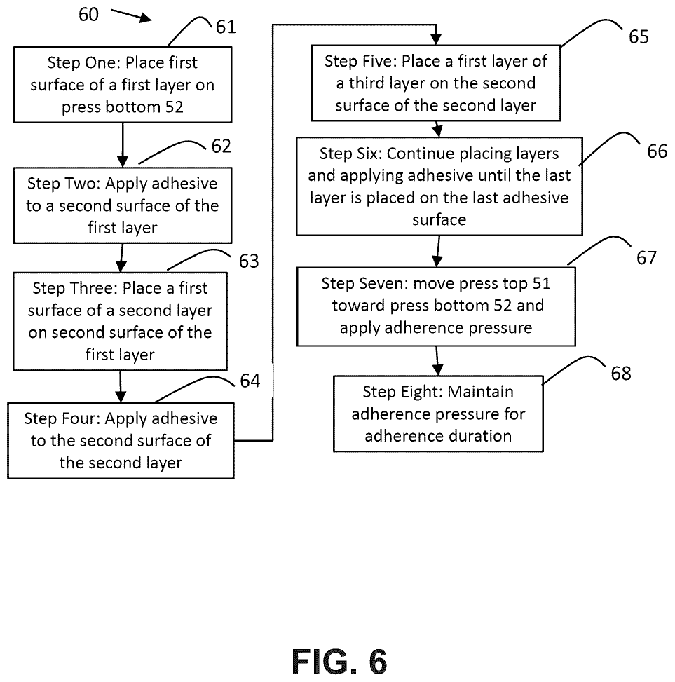

FIG. 6 depicts a flowchart of one adhesion method 60 that may be used to make a multilayer sheet material consistent with the present disclosure.

A first Step 61 includes placing the first surface of the first layer on a press surface of a press bottom 52. This step 61 may include accurately locating the first layer onto the press bottom 52 using locating features such as pins or shoulders (not shown).

A second Step 62 includes applying adhesive to the second surface of the first layer. The step 62 of applying adhesive may, for example, include rolling adhesive onto the second surface of the first layer, inspecting the adhesive for voids, and filling any voids with adhesive using a roller or other application device. The adhesive may be applied with a roller to ensure a consistent layer of adhesive. However, other techniques of applying the adhesive may also be used such as spraying, smearing, and dispensing (manually or automatically). The adhesive is applied such that it is continuous on the layer surfaces to be adhered.

A third Step 63 includes placing the first surface of a second layer (wood, if the first layer is metal; metal, if the first layer is wood) on the second surface of the first layer such that adhesive applied in the second Step 62 contacts the first surface of the second layer. This Step 63 may also optionally include accurately locating the second layer onto the first layer using locating features such as pins or shoulders. This Step 63 may also optionally include applying a layer of adhesive on the first surface of the second layer before contacting the first surface of the second layer with the second surface of the first layer.

A fourth Step 64 includes applying adhesive to the second surface of the second layer. The step 64 of applying adhesive may, for example, include rolling adhesive onto the second surface of the second layer, inspecting the adhesive for voids, and filling any voids with adhesive using a roller or other application device.

A fifth Step 65 includes placing a first surface of a third layer (wood, if the second layer is metal; metal, if the second layer is wood) on the second surface of the second layer such that adhesive applied in the fourth Step 64 contacts the third layer. This step 65 may also optionally include accurately locating the third layer onto the second layer using locating features such as pins or shoulders. This Step 65 may also optionally include applying a layer of adhesive on the first surface of the third layer before contacting the first surface of the third layer with the second surface of the second layer.

A sixth Step 66 includes placing layers and adhesive according to Step 62 through Step 66 until the last layer of material is placed. When the last layer is placed the process is ready for the curing Step 67.

Curing Step 67 includes causing the adhesive to cure to form the final multilayer material. For example, Step 67 may include moving the press top 51 toward the press bottom 52 with the alternating layers of wood and metal (and adhesive between each) disposed between the press top 51 and the press bottom 52 to create an adherence pressure. The adherence pressure may be created by any suitable means including, for example, hydraulic or pneumatic pressure in a cylinder, a simple weight, a motor turning a screw in a nut (or a motor turning a nut on a screw), a linear motor. Step 67 may alternatively include causing the adhesive to cure under vacuum pressure, for example in a vacuum bag associated with a vacuum press (e.g., Industrial AirPress, AirPress Development Limited, Wiltshire UK).

An eighth Step 68 includes maintaining the top force 54 and the opposing bottom force 55 (or alternatively the vacuum force) until an adherence duration has been met. The adherence duration refers to an amount of time sufficient to enable the adhesive to cure sufficiently to effectively (e.g., semi-permanently or permanently) retain each layer of the multilayer material to its adjacent layer(s).

The pressure applied to the multilayer material during the Step 68 of maintaining (also referred to as the adherence pressure) may be about 8 psi to about 20 psi, for example about 11.3 psi (23 inches mercury) when using a press, or about −5 psi to about −25 psi when using a vacuum press.

The adherence pressure is applied for a duration (also referred to as the adherence duration) sufficient to enable the adhesive to cure sufficiently to effectively (e.g., semi-permanently or permanently) retain each layer of the multilayer material to its adjacent layer(s). In some embodiments, the adherence duration is about 4 hours to about 16 hours, or about 10 hours.

One of skill in the art will recognize that the adherence pressure and the adherence duration may vary depending on temperature and the type and amount of adhesive disposed between each layer. For example, applying heat to the multilayer material via the press top 51 and/or the press bottom 52 may decrease the adherence duration and/or the adherence pressure.

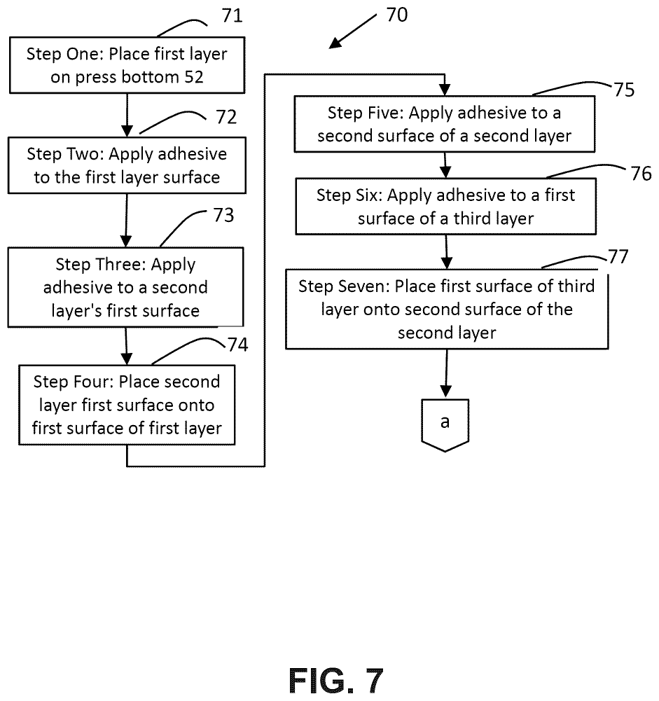

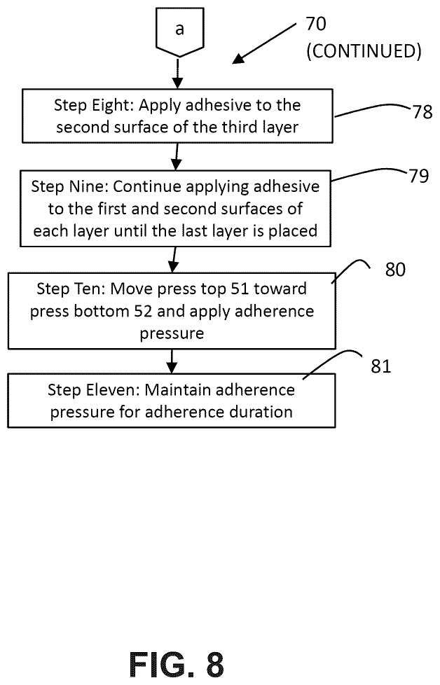

FIGS. 7 and 8 depict a flowchart for a method 70 of making a multilayer material consistent with the present disclosure.

A first Step 71 includes placing a first layer on a press bottom 52. This step 71 may also optionally include accurately locating the first layer onto the press bottom 52 using locating features such as pins or shoulders.

A second Step 72 includes applying adhesive to a first surface of the first layer. The step 72 of applying adhesive may include, for example, rolling adhesive onto first layer surface, inspecting the adhesive for voids, and filling any voids with adhesive using a roller or other application device.

A third Step 73 includes applying adhesive to the first surface of a second layer. The step 73 of applying adhesive may include rolling adhesive onto a first surface of the second layer, inspecting the adhesive for voids, and filling any voids with adhesive using a roller or other application device.

A fourth Step 74 includes placing the first surface (including the adhesive applied in Step 73) of the second layer onto the first surface of the first layer. This step 74 may optionally include accurately locating the second layer to the first layer using locating features such as pins or shoulders.

A fifth Step 75 includes applying adhesive to the second surface of the second layer. The step 75 of applying adhesive may include, for example, rolling adhesive onto the second surface of the second layer, inspecting the adhesive for voids, and filling any voids with adhesive using a roller or other application device.

A sixth Step 76 includes applying adhesive to the first surface of a third layer. The step 76 of applying adhesive may include, for example, rolling adhesive onto a first surface of the third layer, inspecting the adhesive for voids, and filling any voids with adhesive using a roller or other application device.

A seventh Step 77 includes placing the first surface (including the adhesive applied in Step 76) of the third layer onto the second surface of the second layer. This step 77 may optionally include accurately locating the third layer to the second layer using locating features such as pins or shoulders.

An eighth Step 78 includes applying adhesive to the second surface of the third layer. The step 78 of applying adhesive may include, for example, rolling adhesive onto a second surface of the third layer, inspecting the adhesive for voids, and filling any voids with adhesive using a roller or other application device.

A ninth Step 79 includes continuing to apply subsequent layers and adhesive t essentially as described in Step 76 through Step 78 until the last layer is placed. The method does not include applying a layer of adhesive on the second (outer, exposed) surface of the last layer before curing.

A tenth Step 80 includes moving press top 51 toward press bottom 52 and applying an adherence pressure as described above for method 60.

An eleventh Step 81 includes maintaining the top force 54 and the bottom force 55 until for the adherence duration (described above for method 60).

In some embodiments, the present disclosure provides a method of making a multilayer sheet material, the method comprising: placing a first layer onto a bottom surface of a press having a top and bottom surface; applying an adhesive to the first layer; placing a second layer onto the first layer; applying an adhesive to the second layer; placing a third layer onto the second layer; lowering the top surface of the press onto the third layer; applying an adhesion pressure to first layer, second layer and third layer; and maintaining the adhesion pressure for an adhesion duration.

In some embodiments, the present disclosure provides a method of making a multilayer sheet material, the method comprising: placing a first surface of first layer having a first surface and a second surface onto a bottom surface of a press having a top and bottom surface; applying an adhesive to the second surface of the first layer; applying an adhesive to a first surface of a second layer having a first and second surface; placing the first surface of the second layer onto the second surface of the first layer; applying an adhesive to the second surface of the second layer; applying an adhesive to the first surface of a third layer having a first surface and a second surface; placing the first surface of the third layer onto the second surface of the second layer; lowering the top surface of the press onto the second surface of the third layer; applying an adhesion pressure to first layer, second layer and third layer; and maintaining the adhesion pressure for an adhesion duration. In some embodiments, the adhesive is a liquid epoxy. In some embodiments, the adhesive is GFlex (e.g., G/flex® 650 epoxy; West System®, Bay City, Michigan). In some embodiments, the adhesion duration is 10 hours. In some embodiments, the adhesion pressure is at least 11.3 psig. In some embodiments, the bottom surface of the press is heated. In some embodiments, the top surface of the press is heated. In some embodiments, both the top surface and the bottom surface of the press are heated. In some embodiments, at least one layer is wood. In some embodiments, at least one layer is metal. In some embodiments, additional layers are included. In some embodiments, the adhesive is phenolic.

While the present disclosure has been shown and described herein by illustrating the results and advantages over the prior art, the disclosure is not limited to those specific embodiments. Thus, the forms of the disclosure shown and described herein are to be taken as illustrative only and other embodiments may be selected by one having ordinary skill in the art without departing from the scope of the present disclosure.

The disclosed multilayer sheet material is a machinable material that may be worked with most standard woodworking tools such as miter saws, table saws, cnc machining devices, routers, drills and sanders.

Additionally, the disclosed multilayer sheet material may be constructed to include abrasion and chemical resistance. These resistances may be attributed to a metal layer that is exposed to abrasion or chemical contact.

Additionally, the disclosed multilayer sheet material may provide magnetic and electromagnetic advantages. For instance, a metal layer may be ferrous and provide for handling sheets of multilayer sheet material using a magnet. Additionally, a metal layer may be used to provide shielding of electronic devices. This shielding may be used to provide additional security.

The term “consisting essentially of” as used herein generally means that the specified material or method includes the recited components or steps, and may additionally include components or steps that do not materially affect the basic and novel characteristic(s) of the material or method.

As used herein, labels such as “first,” “second,” and “third” do not specify any priority, but are merely descriptors for clarity. An object may be a first object in a first example, and may be re-labeled as a third object in a second example.

As used herein, ASTM is an abbreviation for American Society for Testing and Materials. ASTM has established several standard tests for determining test properties. Using these standard tests, various materials may be compared consistently.

As used herein, AISI is an abbreviation for American Iron and Steel Institute. AISI has provided a ranking system for several metal properties. One of these properties is machinability.

### EXAMPLES

### Example 1

A three-layered sheet material 10 generally consistent with FIG. 1 was prepared from walnut and brass. A sheet of walnut 11 having a thickness of about 1.2 mm was adhered to a sheet of brass 12 having a thickness of about 1.3 mm with a thin layer of G/Flex 650 Toughened Epoxy (West System; Bay City, Michigan). A second sheet of walnut 13 having a thickness of about 1.2 mm was adhered to the opposite face of the brass sheet with a thin layer of G/Flex 650 Toughened Epoxy (West System; Bay City, Michigan) such that the grain directions of the two sheets of walnut aligned. The epoxy was cured by applying pressure on the opposite faces of the walnut sheets at about 11.3 psi for about 10 hours at ambient temperature. The resulting three-layered sheet material 10 had an overall thickness of about 4.1 mm and was rigid to flex and torsion forces.

### Example 2

A five-layered sheet material 30 generally consistent with the present disclosure was prepared from alternating layers of walnut and brass. A first sheet of brass 32 having a thickness of about 1.3 mm was adhered to a first sheet of walnut 33 having a thickness of about 1.2 mm with a thin layer of G/Flex 650 Toughened Epoxy (West System; Bay City, Michigan). A second sheet of brass 34 having a thickness of about 1.3 mm was adhered to the opposite face of the first sheet of walnut 33 with a thin layer of G/Flex 650 Toughened Epoxy (West System; Bay City, Michigan). A second sheet of walnut 31 having a thickness of about 1.2 mm was adhered to the exposed face of the first brass sheet 32 with a thin layer of G/Flex 650 Toughened Epoxy (West System; Bay City, Michigan) such that the grain directions of the first and second sheets of walnut aligned. A third sheet of walnut 35 was adhered to the exposed face of the second brass sheet 34 with a thin layer of G/Flex 650 Toughened Epoxy (West System; Bay City, Michigan) such that the grain directions of the first, second, and third sheets of walnut aligned. The epoxy was cured by applying pressure on the opposite faces of the second and third brass sheets at about 11.3 psi for about 10 hours at ambient temperature. The resulting five-layered sheet material had an overall thickness of about 6.3 mm and was rigid to flex and torsion forces.

### Example 3

A seven-layered sheet material generally consistent with the present disclosure was prepared from alternating layers of walnut and brass. A first sheet of walnut having a thickness of about 1.2 mm was adhered to a first sheet of brass having a thickness of about 1.3 mm with a thin layer of G/Flex 650 Toughened Epoxy (West System; Bay City, Michigan). A second sheet of walnut having a thickness of about 1.2 mm was adhered to the exposed face of the first brass sheet with a thin layer of G/Flex 650 Toughened Epoxy (West System; Bay City, Michigan). A second sheet of brass having a thickness of about 1.3 mm was adhered to the exposed face of the first walnut sheet with a thin layer of G/Flex 650 Toughened Epoxy (West System; Bay City, Michigan). A third sheet of brass having a thickness of about 1.3 mm was adhered to the exposed face of the second walnut sheet with a thin layer of G/Flex 650 Toughened Epoxy (West System; Bay City, Michigan). A third sheet of walnut having a thickness of about 1.2 mm was adhered to the exposed face of the second brass sheet with a thin layer of G/Flex 650 Toughened Epoxy (West System; Bay City, Michigan). A fourth sheet of walnut having a thickness of about 1.2 mm was adhered to the exposed face of the third brass sheet with a thin layer of G/Flex 650 Toughened Epoxy (West System; Bay City, Michigan). The epoxy was cured by applying pressure on the opposite faces of the third and fourth walnut sheets at about 11.3 psi for about 10 hours at ambient temperature. The resulting seven-layered sheet material had an overall thickness of about 9.3 mm and was rigid to flex and torsion forces.

### Example 4

A nine-layered sheet material generally consistent with the present disclosure was prepared from alternating layers of walnut and brass. A first sheet of brass having a thickness of about 1.3 mm was adhered to a first sheet of walnut having a thickness of about 1.2 mm with a thin layer of G/Flex 650 Toughened Epoxy (West System; Bay City, Michigan). A second sheet of brass having a thickness of about 1.3 mm was adhered to the opposite (open) face of the first walnut sheet with a thin layer of G/Flex 650 Toughened Epoxy (West System; Bay City, Michigan). A second sheet of walnut having a thickness of about 1.2 mm was adhered to the exposed face of the first brass sheet with a thin layer of G/Flex 650 Toughened Epoxy (West System; Bay City, Michigan) such that the grain directions of the two walnut sheets aligned. A third sheet of walnut having a thickness of about 1.2 mm was adhered to the exposed face of the second brass sheet with a thin layer of G/Flex 650 Toughened Epoxy (West System; Bay City, Michigan) such that the grain directions of the first, second, and third sheets of walnut aligned. A third sheet of brass having a thickness of about 1.3 mm was adhered to the exposed face of the second sheet of walnut with a thin layer of G/Flex 650 Toughened Epoxy (West System; Bay City, Michigan). A fourth sheet of brass having a thickness of about 1.3 mm was adhered to the exposed face of the third sheet of walnut with a thin layer of G/Flex 650 Toughened Epoxy (West System; Bay City, Michigan). A fourth sheet of walnut having a thickness of about 1.2 mm was adhered to the exposed face of the third brass sheet with a thin layer of G/Flex 650 Toughened Epoxy (West System; Bay City, Michigan) such that the grain directions of the first, second, third, and fourth sheets of walnut aligned. A fifth sheet of walnut having a thickness of about 1.2 mm was adhered to the exposed face of the fourth brass sheet with a thin layer of G/Flex 650 Toughened Epoxy (West System; Bay City, Michigan) such that the grain directions of the first, second, third, fourth, and fifth sheets of walnut aligned. The epoxy was cured by applying pressure on the opposite faces of the walnut sheets at about 11.3 psi for about 10 hours at ambient temperature. The resulting nine-layered sheet material had an overall thickness of about 12.2 mm and was rigid to flex and torsion forces.

### Example 5

A seven-layered material generally consistent with the present disclosure and having an overall curved shape similar to that shown in FIG. 4 was prepared from alternating layers of walnut and brass. A thin layer of G/Flex 650 Toughened Epoxy (West System; Bay City, Michigan) was placed between a first sheet of walnut having a thickness of about 1.2 mm and a first sheet of brass having a thickness of about 1.3 mm. A second thin layer of G/Flex 650 Toughened Epoxy (West System; Bay City, Michigan) was placed between a second sheet of walnut having a thickness of about 1.2 mm and the exposed face of the first brass sheet. A third thin layer of G/Flex 650 Toughened Epoxy (West System; Bay City, Michigan) was placed between a second sheet of brass having a thickness of about 1.3 mm and the exposed face of the first walnut sheet. A fourth thin layer of G/Flex 650 Toughened Epoxy (West System; Bay City, Michigan) was placed between a third sheet of brass having a thickness of about 1.3 mm and the exposed face of the second walnut sheet. A fifth thin layer of G/Flex 650 Toughened Epoxy (West System; Bay City, Michigan) was placed between a third sheet of walnut having a thickness of about 1.2 mm and the exposed face of the second brass sheet. A sixth thin layer of G/Flex 650 Toughened Epoxy (West System; Bay City, Michigan) was placed between a fourth sheet of walnut having a thickness of about 1.2 mm and the exposed face of the third brass sheet. The multilayered assembly was placed in a press including complementary curved jaws. The epoxy was cured by applying pressure to the curved jaws (and the multilayer assembly included therein) at about 11.3 psi for about 10 hours at ambient temperature. The resulting seven-layered sheet material had a curved (e.g., about 90° cross-sectional profile shape), an overall thickness of about 9.3 mm, and was rigid to flex and torsion forces.

### Example 6

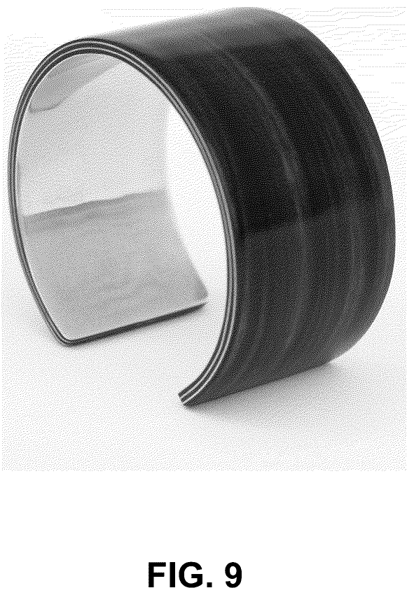

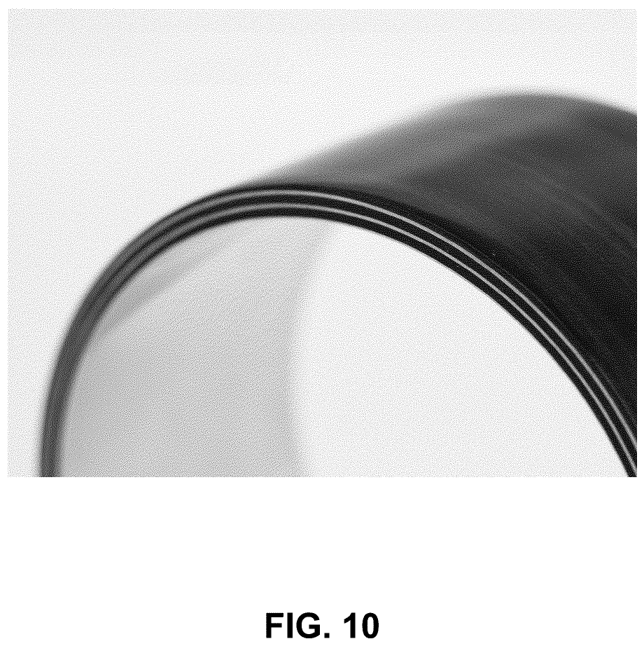

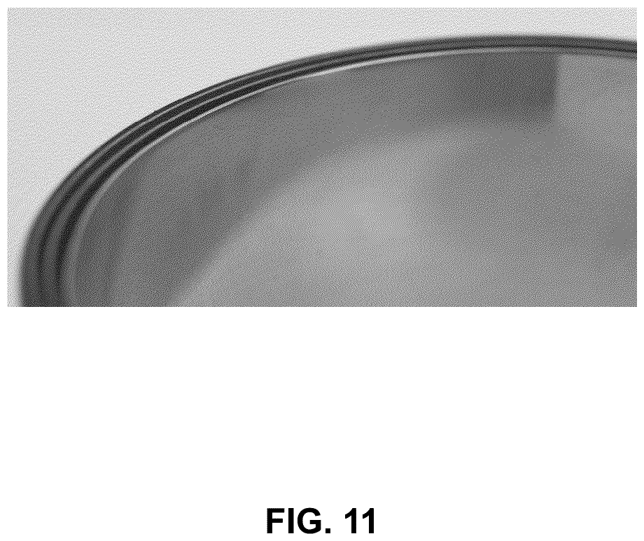

A six-layered material generally consistent with the present disclosure and having an overall curved shape similar to that shown in FIGS. 9-11 was prepared from alternating layers of Macassar ebony wood and brass. A thin layer of G/Flex 650 Toughened Epoxy (West System; Bay City, Michigan) was placed between a first sheet of ebony having a thickness of about 0.8 mm and a first sheet of brass having a thickness of about 0.5 mm. A second thin layer of G/Flex 650 Toughened Epoxy (West System; Bay City, Michigan) was placed between a second sheet of ebony having a thickness of about 0.8 mm and the exposed face of the first brass sheet. A third thin layer of G/Flex 650 Toughened Epoxy (West System; Bay City, Michigan) was placed between a second sheet of brass having a thickness of about 0.5 mm and the exposed face of the first ebony sheet. A fourth thin layer of G/Flex 650 Toughened Epoxy (West System; Bay City, Michigan) was placed between a third sheet of brass having a thickness of about 0.5 mm and the exposed face of the second ebony sheet. A fifth thin layer of G/Flex 650 Toughened Epoxy (West System; Bay City, Michigan) was placed between a third sheet of ebony having a thickness of about 0.8 mm and the exposed face of the second brass sheet. The multilayered assembly was placed in a press including complementary curved jaws. The epoxy was cured by applying pressure to the curved jaws (and the multilayer assembly included therein) at about 11.3 psi for about 10 hours at ambient temperature. The resulting six-layered sheet material had a curved (e.g., circular cross-sectional profile shape), an overall thickness of about 5 mm, and was rigid to flex and torsion forces.

### Example 7

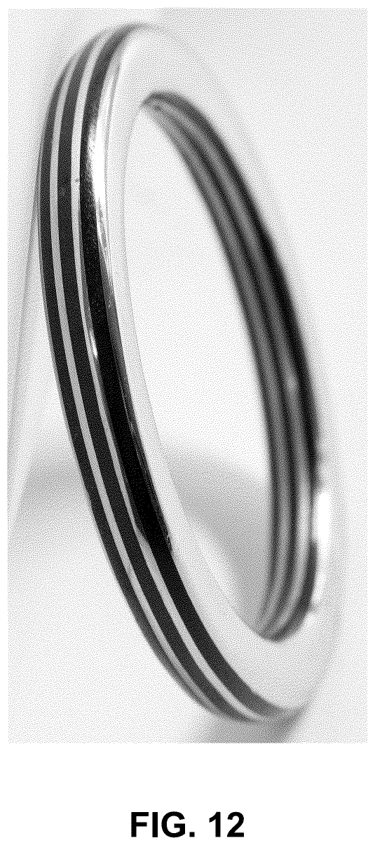

A seven-layered material generally consistent with the present disclosure and having an overall curved shape similar to that shown in FIG. 12 was prepared from alternating layers of walnut and brass. A thin layer of G/Flex 650 Toughened Epoxy (West System; Bay City, Michigan) was placed between a first sheet of brass having a thickness of about 1 mm and a first sheet of walnut having a thickness of about 1.58 mm. A second thin layer of G/Flex 650 Toughened Epoxy (West System; Bay City, Michigan) was placed between a second sheet of brass having a thickness of about 1 mm and the exposed face of the first walnut sheet. A third thin layer of G/Flex 650 Toughened Epoxy (West System; Bay City, Michigan) was placed between a second sheet of walnut having a thickness of about 1.58 mm and the exposed face of the second brass sheet. A fourth thin layer of G/Flex 650 Toughened Epoxy (West System; Bay City, Michigan) was placed between a third sheet of brass having a thickness of about 1 mm and the exposed face of the second walnut sheet. A fifth thin layer of G/Flex 650 Toughened Epoxy (West System; Bay City, Michigan) was placed between a third sheet of walnut having a thickness of about 1.58 mm and the exposed face of the third brass sheet. A sixth thin layer of G/Flex 650 Toughened Epoxy (West System; Bay City, Michigan) was placed between a fourth sheet of brass having a thickness of about 1 mm and the exposed face of the third walnut sheet. The multilayered assembly was placed in a press. The epoxy was cured by applying pressure to the press (and the multilayer assembly included therein) at about 11.3 psi for about 10 hours at ambient temperature. The resulting seven-layered sheet material was cut and sanded to form the ring shape depicted in FIG. 12, and was rigid to flex and torsion forces.

### Example 8

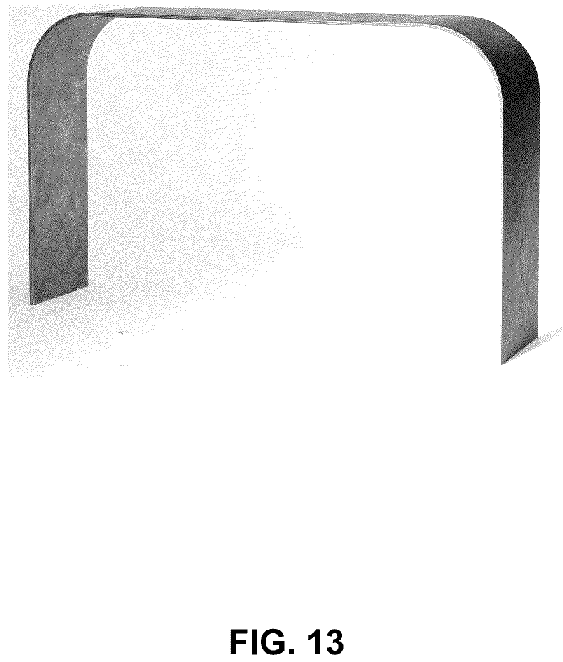

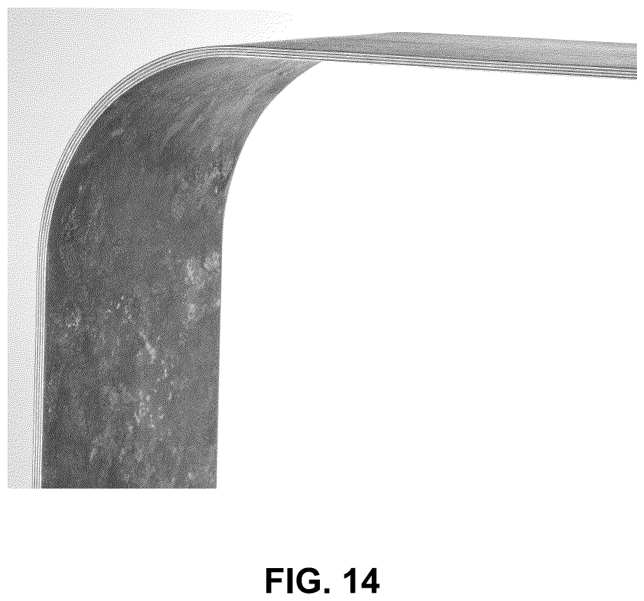

An eight-layered material generally consistent with the present disclosure and having an overall curved shape similar to that shown in FIGS. 13-14 was prepared from alternating layers of fumed oak wood and bronze. A thin layer of G/Flex 650 Toughened Epoxy (West System; Bay City, Michigan) was placed between a first sheet of fumed oak having a thickness of about 1.4 mm and a first sheet of bronze having a thickness of about 1 mm. A second thin layer of G/Flex 650 Toughened Epoxy (West System; Bay City, Michigan) was placed between a second sheet of fumed oak having a thickness of about 1.4 mm and the exposed face of the first bronze sheet. A third thin layer of G/Flex 650 Toughened Epoxy (West System; Bay City, Michigan) was placed between a second sheet of bronze having a thickness of about 1 mm and the exposed face of the second fumed oak sheet. A fourth thin layer of G/Flex 650 Toughened Epoxy (West System; Bay City, Michigan) was placed between a third sheet of fumed oak having a thickness of about 1.4 mm and the exposed face of the second bronze sheet. A fifth thin layer of G/Flex 650 Toughened Epoxy (West System; Bay City, Michigan) was placed between a third sheet of bronze having a thickness of about 1 mm and the exposed face of the second fumed oak sheet. A fifth thin layer of G/Flex 650 Toughened Epoxy (West System; Bay City, Michigan) was placed between a fourth sheet of fumed oak having a thickness of about 1.4 mm and the third sheet of bronze. A sixth thin layer of G/Flex 650 Toughened Epoxy (West System; Bay City, Michigan) was placed between a fourth sheet of bronze having a thickness of about 1 mm and the fourth fumed oak sheet. The multilayered assembly was placed in a press including complementary shaped jaws. The epoxy was cured by applying pressure to the curved jaws (and the multilayer assembly included therein) at about 11.3 psi for about 10 hours at ambient temperature. The resulting eight-layered sheet material had a curved cross-sectional contour (e.g., including two 90 rounded turns), an overall thickness of about 10 mm, and was rigid to flex and torsion forces.

### Example 9

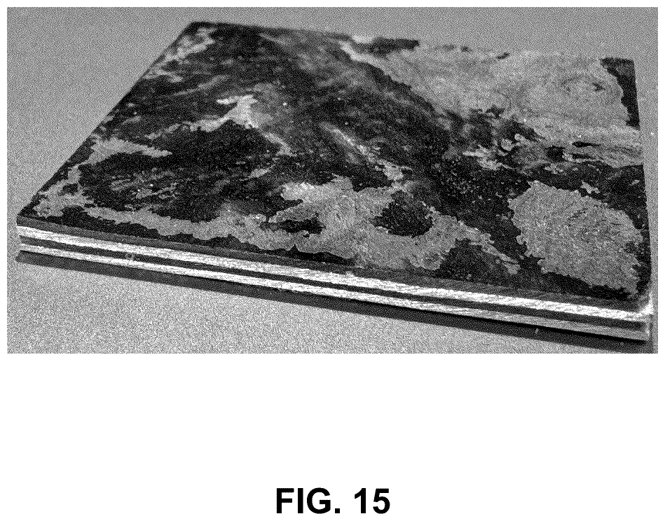

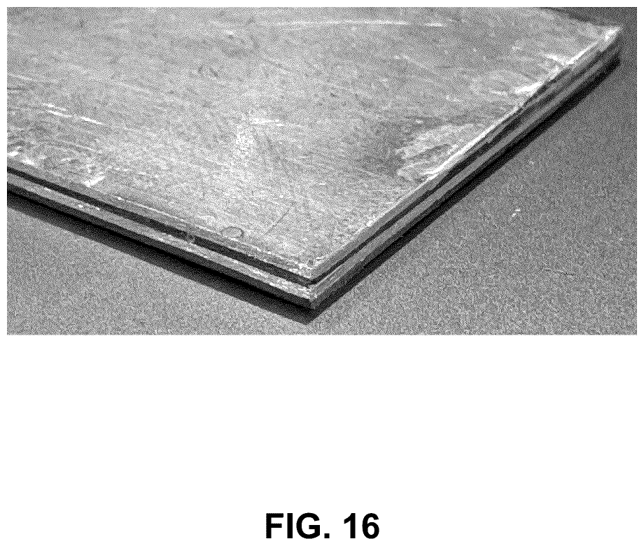

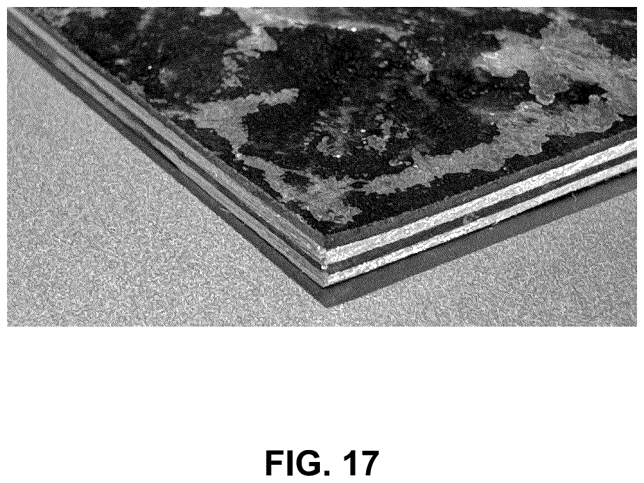

A four-layered material generally consistent with the present disclosure and having an overall curved shape similar to that shown in FIGS. 15-17 was prepared from alternating layers of walnut burl wood and 0.999 silver. A thin layer of G/Flex 650 Toughened Epoxy (West System; Bay City, Michigan) was placed between a first sheet of walnut burl having a thickness of about 0.57 mm and a first sheet of 0.999 silver having a thickness of about 0.75 mm. A second thin layer of G/Flex 650 Toughened Epoxy (West System; Bay City, Michigan) was placed between a second sheet of walnut burl having a thickness of about 0.57 mm and the exposed face of the first silver sheet. A third thin layer of G/Flex 650 Toughened Epoxy (West System; Bay City, Michigan) was placed between a second sheet of 0.999 silver having a thickness of about 0.75 mm and the exposed face of the second walnut burl sheet. The multilayered assembly was placed in a press. The epoxy was cured by applying pressure to the curved jaws (and the multilayer assembly included therein) at about 11.3 psi for about 10 hours at ambient temperature. The resulting four-layered sheet material had an overall thickness of about 2.8 mm, and was rigid to flex and torsion forces.

### Example 10

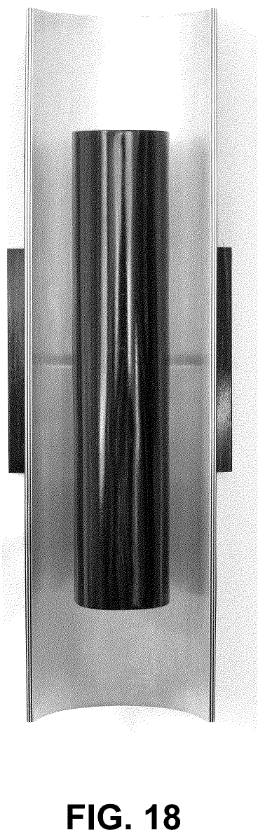

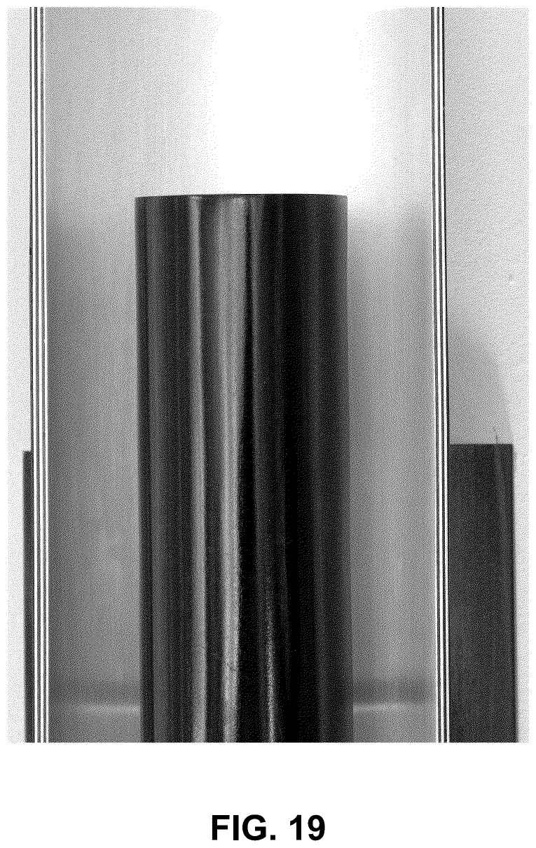

A wall sconce as shown in FIGS. 18-19 was prepared from two multilayered sheet materials prepared consistent with the present disclosure.

The rear wall-adjacent component of the wall sconce comprised a six-layered material including alternating layers of Macassar ebony wood and aluminum. A thin layer of G/Flex 650 Toughened Epoxy (West System; Bay City, Michigan) was placed between a first sheet of ebony having a thickness of about 0.9 mm and a first sheet of aluminum having a thickness of about 0.64 mm. A second thin layer of G/Flex 650 Toughened Epoxy (West System; Bay City, Michigan) was placed between a second sheet of ebony having a thickness of about 0.9 mm and the exposed face of the first aluminum sheet. A third thin layer of G/Flex 650 Toughened Epoxy (West System; Bay City, Michigan) was placed between a second sheet of aluminum having a thickness of about 0.64 mm and the exposed face of the second ebony sheet. A fourth thin layer of G/Flex 650 Toughened Epoxy (West System; Bay City, Michigan) was placed between a third sheet of ebony having a thickness of about 0.9 mm and the exposed face of the second aluminum sheet. A fifth thin layer of G/Flex 650 Toughened Epoxy (West System; Bay City, Michigan) was placed between a third sheet of aluminum having a thickness of about 0.64 mm and the exposed face of the third ebony sheet. The multilayered assembly was placed in a vacuum bag and drawn against a curved form using a vacuum pump at ambient temperature until the epoxy cured. The resulting six-layered sheet material had a curved (e.g., semicircular cross-sectional profile shape), an overall thickness of about 5 mm, and was rigid to flex and torsion forces.

The front reflector component of the wall sconce comprised a six-layered material including alternating layers of Macassar ebony wood and aluminum. A thin layer of G/Flex 650 Toughened Epoxy (West System; Bay City, Michigan) was placed between a first sheet of ebony having a thickness of about 0.6 mm and a first sheet of aluminum having a thickness of about 0.5 mm. The two-layered assembly was placed in a press including complementary curved jaws. The epoxy was cured by applying pressure to the curved jaws (and the multilayer assembly included therein) at about 11.3 psi for about 10 hours at ambient temperature. The resulting two-layered sheet material had a curved (e.g., semicircular cross-sectional profile shape), an overall thickness of about 1.3 mm, and was rigid to flex and torsion forces.

### Example 11

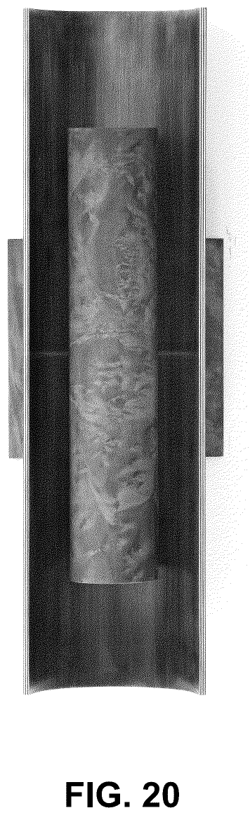

A wall sconce as shown in FIG. 20 was prepared from two multilayered sheet materials prepared consistent with the present disclosure.

The rear wall-adjacent component of the wall sconce comprised a nine-layered material including layers of madrone burl wood and zinc. A thin layer of G/Flex 650 Toughened Epoxy (West System; Bay City, Michigan) was placed between a first sheet of madrone burl having a thickness of about 0.45 mm and a second sheet of madrone burl having a thickness of about 0.45 mm. A second thin layer of G/Flex 650 Toughened Epoxy (West System; Bay City, Michigan) was placed between a first sheet of zinc having a thickness of about 0.64 mm and the exposed face of the second sheet of madrone burl. A third thin layer of G/Flex 650 Toughened Epoxy (West System; Bay City, Michigan) was placed between a third sheet of madrone burl having a thickness of about 0.45 mm and the exposed face of the first layer of zinc. A fourth thin layer of G/Flex 650 Toughened Epoxy (West System; Bay City, Michigan) was placed between a fourth layer of madrone burl having a thickness of about 0.45 mm and the exposed face of the third layer of madrone burl. A fifth thin layer of G/Flex 650 Toughened Epoxy (West System; Bay City, Michigan) was placed between a second layer of zinc having a thickness of about 0.64 mm and the exposed face of the fourth layer of madrone burl. A sixth thin layer of G/Flex 650 Toughened Epoxy (West System; Bay City, Michigan) was placed between a fifth sheet of madrone burl having a thickness of about 0.45 mm and the exposed face of the second layer of zinc. A seventh thin layer of G/Flex 650 Toughened Epoxy (West System; Bay City, Michigan) was placed between a sixth sheet of madrone burl having a thickness of about 0.45 mm and the exposed face of the fifth layer of madrone burl. An eighth thin layer of G/Flex 650 Toughened Epoxy (West System; Bay City, Michigan) was placed between a third sheet of zinc and the exposed face of the sixth layer of madrone burl. The multilayered assembly was placed in a vacuum bag and drawn against a curved form using a vacuum pump at ambient temperature until the epoxy cured. The resulting nine-layered curved component had a curved (e.g., semicircular cross-sectional profile shape), an overall thickness of about 5 mm, and was rigid to flex and torsion forces. The exposed third layer of zinc was then blackened using conventional methods.

The front reflector component of the wall sconce comprised a six-layered material including alternating layers of Madrone burl wood and zinc. A thin layer of G/Flex 650 Toughened Epoxy (West System; Bay City, Michigan) was placed between a first sheet of Madrone burl having a thickness of about 0.6 mm and a first sheet of zinc having a thickness of about 0.5 mm. A second thin layer of G/Flex 650 Toughened Epoxy (West System; Bay City, Michigan) was placed between a second layer of zinc having a thickness of about 0.5 mm and the exposed face of the first sheet of Madrone burl. A third thin layer of G/Flex 650 Toughened Epoxy (West System; Bay City, Michigan) was placed between a second layer of Madrone burl having a thickness of about 0.6 mm and the exposed face of the second sheet of zinc. A fourth thin layer of G/Flex 650 Toughened Epoxy (West System; Bay City, Michigan) was placed between a third layer of zinc having a thickness of about 0.5 mm and the exposed face of the second layer of Madrone burl. A fifth thin layer of G/Flex 650 Toughened Epoxy (West System; Bay City, Michigan) was placed between a third layer of Madrone burl having a thickness of about 0.6 mm and the exposed face of the third layer of zinc. The six-layered assembly was placed in a press including complementary curved jaws. The epoxy was cured by applying pressure to the curved jaws (and the multilayer assembly included therein) at about 11.3 psi for about 10 hours at ambient temperature. The resulting six-layered sheet material had a curved (e.g., semicircular cross-sectional profile shape), an overall thickness of about 1.3 mm, and was rigid to flex and torsion forces.

1: A multilayer sheet material comprising:
a first wood layer;
a second metal layer adjacent to the first wood layer; and
a third layer adjacent to either the first wood layer or the second metal layer.

2: The multilayer sheet material of claim 1 further comprising an adhesive layer disposed between the first wood layer and the second metal layer.

3: The multilayer sheet material of claim 1, wherein the first wood layer has a thickness of about 0.2 mm to about 8 mm.

4: The multilayer sheet material of claim 1, wherein the first wood layer comprises, consists essentially of, or consists of a wood capable of being adhered to metal with an adhesive.

5: The multilayer sheet material of claim 4, wherein the first wood layer is selected from the group consisting of: walnut, oak, cherry, cedar, mahogany, ash, maple, redwood, hickory, ebony, and sapele.

6: The multilayer sheet material of claim 1, wherein the second metal layer has a thickness of about 0.2 mm to about 12 mm.

7: The multilayer sheet material of claim 6, wherein the second metal layer comprises, consists essentially of, or consists of a machinable metal.

8: The multilayer sheet material of claim 7, wherein the machinable metal is selected from the group consisting of: brass, bronze, copper, aluminum, zinc, silver, a precious metal, and free machining steel.

9: The multilayer sheet material of claim 1, wherein the third layer is adjacent to the second metal layer and has a thickness of about 0.2 mm to about 8 mm.

10: The multilayer sheet material of claim 9, wherein the third layer comprises, consists essentially of, or consists of a second wood capable of being adhered to metal with an adhesive.

11: The multilayer sheet material of claim 10, wherein the first wood layer is selected from the group consisting of: walnut, oak, cherry, cedar, mahogany, ash, maple, redwood, hickory, ebony, and sapele.

12: The multilayer sheet material of claim 1, wherein the third layer is adjacent to the first wood layer and has a thickness of about 0.2 mm to about 12 mm.

13: The multilayer sheet material of claim 12, wherein the third layer comprises, consists essentially of, or consists of a second machinable metal.

14: The multilayer sheet material of claim 13, wherein the second machinable metal is selected from the group consisting of: brass, bronze, copper, aluminum, zinc, silver, a precious metal, and free machining steel.

15. The multilayer sheet material of claim 1, further comprising an adhesive layer disposed between the first wood layer and the second metal layer.

16-22. (canceled)

23: The multilayer sheet material of claim 9, further comprising an adhesive layer disposed between the second metal layer and the third layer.

24-49. (canceled)

50: A method of making a multilayer sheet material, the method comprising:
placing a first surface of first layer having a first surface and a second surface onto a bottom surface of a press having a top and bottom surface;
applying an adhesive to the second surface of the first layer;
applying an adhesive to a first surface of a second layer having a first and second surface;
placing the first surface of the second layer onto the second surface of the first layer;
applying an adhesive to the second surface of the second layer;
applying an adhesive to the first surface of a third layer having a first surface and a second surface;
placing the first surface of the third layer onto the second surface of the second layer;
lowering the top surface of the press onto the second surface of the third layer;
applying an adhesion pressure to first layer, second layer and third layer; and
maintaining the adhesion pressure for an adhesion duration.

51: The method of claim 50, wherein the adhesive is a liquid epoxy.

52-57. (canceled)

58: The method of claim 50, wherein at least one layer is wood.

59: The method of claim 50, wherein at least one layer is metal.

60-61. (canceled)
